(19) United States
(12) Patent Application Publication
(10) Pub. No.: US 2012/0178592 A1
(43) Pub. Date: Jul. 12, 2012

(54) Mobile gym and exercise bike

(75) Inventors: Hang Chang Chieh, Singapore (SG); Baladhandayuthapan Pachyappa, Singapore (SG)

(73) Assignee: Edison(s) Pte. Ltd.

(21) Appl. No.: 12/930,585

(22) Filed: Jan. 11, 2011

(51) Int. Cl. A63B 22/06; B62K 11/00

(52) U.S. Cl. 482/57; 180/220

(57) ABSTRACT

A bicycle which is made up of a frame, a front and rear wheel, an electric DC motor, a multiple mode selection switch, a torque selection switch, and a rear wheel stand which can either raise the wheel off of a surface or allow the wheel to touch the surface, is described. The multi-purpose bicycle can be used in standard mode, electric mode, stationary gym mode, or mobile gym mode.

### FIELD OF THE INVENTION

The present invention relates generally to a bicycle with an electric motor, and more specifically to an electrically powered bicycle which has multiple uses, including use as a manual bicycle, an electric bicycle that provides torque in the direction the user is pedaling, an electric bicycle that provides torque in the opposite direction the user is pedaling, and as a standalone exercise machine.

### BACKGROUND OF THE INVENTION

Since its invention in the 1860's, the bicycle has been a popular way for people to exercise and enjoy the outdoors. Over the years there have been many different modifications made to the traditional bicycle, as well as many new ways to use it. Some variations, besides the traditional manually pedaled bike, include the electric bicycle and the exercise bicycle.

An electric bicycle is a bicycle with an attached electric motor, which typically assists, to varying degrees, the bicyclist in pedaling his/her bicycle. Vehicles such as mopeds rely almost entirely on the motor, and only require pedaling in an emergency or if the motor dies. On the other hand, pedal-assist bicycles require the use of the pedals as the main form of power. The electric motor is in place to give an extra burst of speed when it is needed, such as when the bicycle is being pedaled uphill. Most electric bicycle motors are powered by NiMH, Nickel-Cadmium, or Lithium-Ion batteries, but some older bicycles have or are still run by lead acid batteries.

Traditionally, the exercise bicycle is a machine with a seat, pedals, and handlebars, which looks just like a bicycle, but without wheels. The main focus of these bicycles is of course for physical exercise, instead of transportation. Usually the exercise bicycle provides some form of resistance to pedaling, in order to increase the work that the user has to do. Forms of resistance include fans, magnets and friction devices. In recent years there has been an increase in the use of mini exercise bikes. These are made up of only pedals and a resistance mechanism. They allow the user to exercise while sitting on a chair or other piece of furniture, and can be moved around the house when needed. Also, competitive bicyclists have been known to place a traditional manual bicycle on rollers, in order to transform the bicycle into a non-moving exercise machine.

U.S. Pat. No. 6,220,991 to Sellers describes a stationary exercise bicycle, in which a motor rotates the pedal crank assembly, as well as the handle bars, in order to assist a physically challenged person in using the bicycle.

U.S. Pat. No. 7,357,209 to Kyosuke et al. describes as aerobic exercise machine, which, through the use of a motor, either assists a user in pedaling, or provides rotational resistance to challenge a user in pedaling.

U.S. Pat. No 5,662,187 to McGovern describes a pedaled bicycle, which combines the torque provided by a motor with the rider's pedal torque, in order to assist the rider in pedaling his/her bicycle.

U.S. Pat. No 7261,175 to Fahrner describes a manually powered bicycle with the left pedal crank arm replaced by a motor driven sprocket and a left pedal assembly, so that the user can, at will, be assisted in pedaling his/her bicycle

Commercial Exercise Machine: http://www.massager-machines-and-more.com/e-z-cycle.htm—The E-Z Cycle Motorized Exercise Bike is a machine that allows for the user to exercise his/her legs or arms by pedaling the machine's pedals with varying degrees of motorized assistance.

Rear Wheel Driven Electric Bike: http://www.greenspeed.us/bionx motor bike kit.htm—The Bionx Electric Bike Motor Conversion Kit allows the user to transform their manually pedaled bike into a rear wheel driven electric bike.

### SUMMARY OF THE INVENTION

An object of the invention is to provide a multi-use bicycle, able to be used in different modes of operation. The different modes of operation include use as a standard bicycle, an electric bicycle with power resistance, a standalone exercise machine, or a standalone exercise machine with power resistance.

Another object of the invention is to provide one mode of operation, in which the bicycle is pedaled like a standard bicycle.

A still further object of the invention is to provide another mode of operation, in which an electric motor is turned on and the bicycle is transformed into an electric bicycle, which either assists the bicyclist in pedaling, or creates resistance to the bicyclists pedaling, operating as a “Gym on the go”, simulating the effect of climbing a slope while pedaling on a flat surface.

Another object of the invention is to provide a third mode of operation, in which the bicycles back wheel is lifted off the ground and the bicycle is used as a standalone exercise gym. In addition to being used for exercise, the pedaling performed on the standalone exercise gym recharges the battery in the electric motor.

A last object of the invention is to provide a final mode of operation, in which the bicycles back wheel is lifted off the ground, in addition to the motor being turned on. Thus the bicycle can be used as a standalone exercise gym, which either assists the user in pedaling, or creates resistance to the user's pedaling. The above and other objects of the present invention may be accomplished in the following manner.

These objects are achieved by a bicycle which is made up of a frame, a front and rear wheel, an electric DC motor, and a rear wheel stand which can either raise the wheel off of a surface or allow the wheel to touch the surface.

The objects are also achieved by a multi-purpose bicycle, which is made up of a frame, a front and rear wheel, an electric DC motor, a multiple mode selection switch, and a torque selection switch.

The objects are further achieved by a method of using a multi-purpose bicycle which is made up of a frame, a front and rear wheel, an electric DC motor, a multiple mode selection switch, and a torque selection switch. The multi-purpose bicycle can be used in standard mode, electric mode, stationary gym mode, or mobile gym mode.

### BRIEF DESCRIPTION OF THE DRAWINGS

The present invention will be more clearly understood from the following description taken in conjunction with the accompanying drawings in which like reference numerals designate similar or corresponding elements, regions and portions and in which:

FIG. 1 shows the bicycle of the invention with a rear wheel stand in which pedaling creates forward movement, and for which there can be an opposing torque on the rear wheel.

FIG. 2 is a flow diagram of the mode selection and torque selection switches of the invention, and how they work together with the electric motor, charging unit and battery.

FIG. 3 is a flow diagram of the 4 different ways of using the multi-purpose bicycle of the invention.

### DETAILED DESCRIPTION OF THE PREFERRED EMBODIMENT

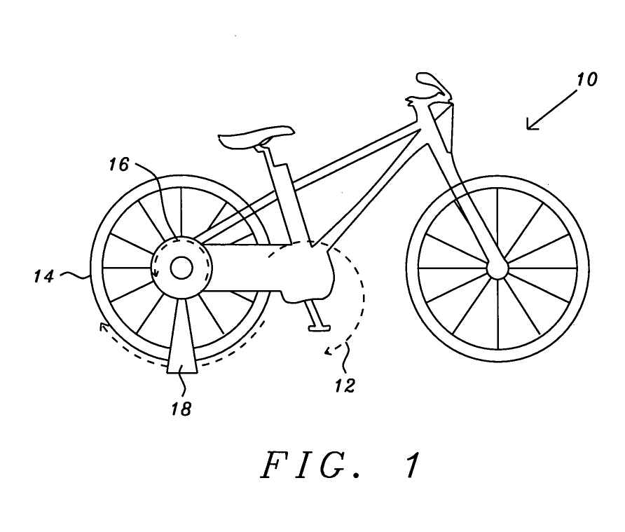

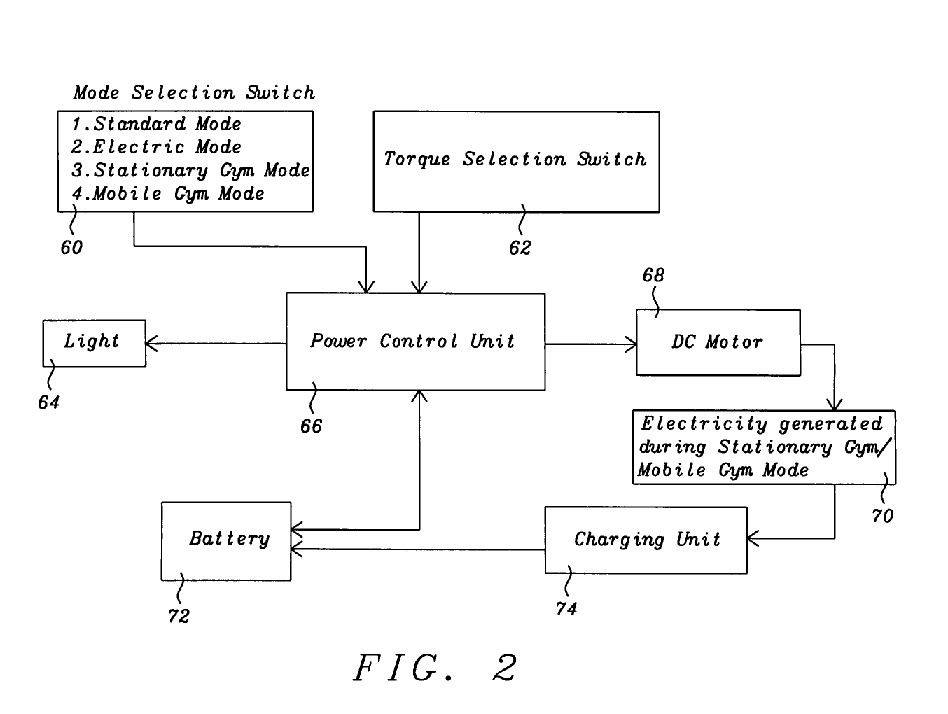

Referring now to FIG. 1, the invention includes a lightweight bicycle 10, with a rear wheel 14 and a rear wheel stand 18, which can be used in four different modes of operation. Each mode involves a pedaling forward movement 12 by a user, and possibly a rear wheel opposing torque 16, which is created by a direct contact electric motor 17, which is preferably mounted to the rear wheel of the bicycle 10. Optionally, electric motor 17 can also be positioned next to the pedals of the bicycle 10. In addition to use of the direct contact electric motor 17, a chain driven, or rubber belt driven motor can also be used. It is primarily for maintenance and cost reasons that motor mounting inside the rear wheel is preferred, to eliminate need for mechanical transmission and/or friction components. Referring to FIG. 2, a block diagram of the invention is shown. A mode selection switch 60 is used to switch between standard bicycle mode, electric bicycle mode, stationary gym mode, and mobile gym mode. Torque selection switch 62 is utilized to switch between forward torque and backward torque in the two modes in which the electric motor 68 is running. The torque selection switch module will also contain an intensity control switch, which controls how much aid to pedaling or resistance to pedaling the electric motor 17 provides. Torque selection switch 62 and mode selection switch 60 are preferably mounted on the bicycle handlebars. Both selection switches, as well as the intensity control switch, send signals to power control unit 66, which in turn runs electric motor 68 either forward or backward, and at varying intensities. The power control unit 66 also is used to turn a light 64—preferably mounted on a front, or optionally on the back, of the bicycle of the invention—on or off. During stationary gym/mobile gym modes, electricity is optionally generated 70 and charging unit 74 charges battery 72, based on a battery charge condition monitored by power control unit 66. Battery 72 preferably provides power through power control unit 66 in order to power electric motor 68 and light 64.

The electric motor 68 that is used is preferably a brushless Direct Current (DC) motor, but, optionally any other type of DC or Alternative Current (AC) motor can be used. The electric motor 17 is turned on by the main power switch and controlled by the intensity control switch. Battery 72 is rechargeable and may be any of the available rechargeable battery chemistries, including nickel-cadmium, lithium ion, lead acid, lithium polymer, lithium ferrite phosphate, lithium metal phosphate, or nickel metal hydride.

When the mode selection switch 60 is in manual cycle mode, the motor 68 is off and the bicycle 10 can be used as a standard pedaled bicycle. Pedaling forward movement 12 produces all the force that propels the bicycle 10 forward.

When the mode selection switch 60 is placed in electric bicycle mode, the motor 68 is turned on and there are two ways that the bicycle 10 can be used. If the torque selection switch 62 is switched to forward, then the bicycle 10 functions as a normal electric bicycle, in which the motor 68 assists the user in pedaling forward movement 12. On the other hand, if the torque selection switch 62 is switched to backward, the motor 68 provides an opposing torque 16 against movement of the rear wheel 14. This will force the user of the bicycle 10 to put more energy into pedaling forward movement 12, and will create the effect of climbing a hill or mountain.

When the mode selection switch 60 is placed into stationary gym mode, the motor 68 is off and the bicycle 10 functions as a standalone exercise gym. In this mode, a back wheel stand 18 is utilized to lift the back wheel 16, allowing movement of the back wheel 16 without causing the bicycle 10 to move forward. Now, the bicycle 10 can undergo pedaled forward movement 12 like a normal exercise bike, with just the back wheel 16 spinning in the air. An additional feature of this mode is to harness the energy from spinning the back wheel 16 in order to generate electricity 70, to charge the battery 72 in the electric motor 68. When the back wheel 16 is spun, generated electricity 70 passes through charging unit 74, which in turn charges the battery 72.

Finally, when the mode selection switch 60 is placed into mobile gym mode, the motor 68 is on again, and the bicycle 10 once again functions as an exercise bike. The difference in this mode, in addition to the motor 68 being turned on, is found in the orientation of the torque selection switch 62. If the torque selection switch 62 is switched to forward, the motor 68 assists the user in pedaling forward movement 12. If the torque selection switch 62 is switched to backward, the electric motor 68 provides opposing torque 16 against movement of the rear wheel 14 in order to create resistance to pedaling forward movement 12. This gives the user a more strenuous workout. It is also a feature of this mode to harness the energy from spinning the back wheel 16 in order to generate electricity 70, to charge the battery 72 in the electric motor 68. Once again, when the back wheel 16 is spun, generated electricity 70 passes through charging unit 74, which in turn charges the battery 72.

Referring to FIG. 2 there is a mode selection switch 60 and a torque selection switch 62, which are run into power control unit 66, which in turn switches between the different modes that the bicycle 10 can be used in. The power control unit 66 also preferably controls whether light 64 is on or off.

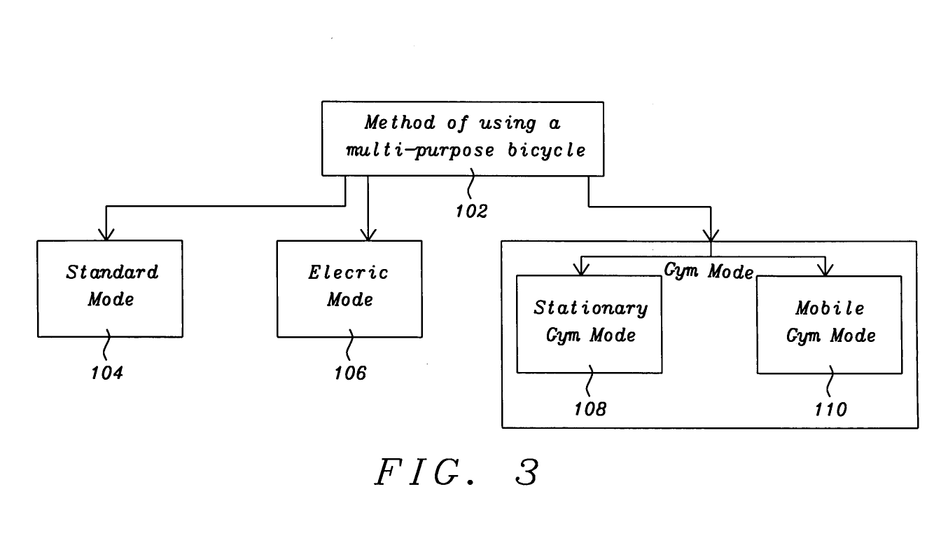

With reference to FIG. 3, a method of using the multi-purpose bicycle 102 of the invention involves four separate modes of operation. The four separate modes include standard mode 104, electric mode 106, stationary gym mode 108, and mobile gym mode 110, as previously described.

### ADVANTAGES OF THE PRESENT INVENTION

The bicycle of the invention combines bicycle riding, transportation, and gym exercise in a single apparatus, and thus is advantageous as it allows use in any or all of the provided modes without having to purchase a separate piece of equipment for each. The user can go bicycle riding for pleasure or exercise. He/she can also use the electric mode on the bicycle for transportation, without the need to purchase and burn gasoline and thus save both expense and prevent carbon emissions. And instead of paying a monthly fee to be a member of an exercise facility the user can use the bicycle as a standalone exercise bicycle.

A second important advantage of the bicycle is use of the motor to produce backward torque to create resistance while the user is pedaling the bicycle, either in mobile gym mode or during regular moving use. This is advantageous because it gives the user a greater workout in a short amount of time.

A last advantage of the bicycle is the easy mobility of the bicycle. Most gym equipment is rather large and bulky and is thus very difficult to move around. Since the invention is only a bicycle it is very easy to move the bicycle and use its gym option in any location, e.g., in a residence or outdoors.

While particular embodiments of the present invention have been illustrated and described, it is not intended to limit the invention, except as defined by the following claims.

What is claimed is:

1. A bicycle, comprising:
a frame;
a front wheel and a rear wheel coupled to said frame;
an electric DC motor operably coupled to one of said wheels; and
a rear wheel stand, which in one position raises said rear wheel off a surface, and in another position allows said rear wheel to rest on said surface.

2. The bicycle of claim 1, in which said electric DC motor is brushless.

3. The bicycle of claim 1, in which said electric DC motor is directly connected to a hub of said rear wheel, or is connected to said rear wheel by a chain or belt.

4. The bicycle of claim 1, further comprising a rechargeable battery having a nickel-cadmium, lead acid, lithium polymer, lithium ferrite phosphate, lithium metal phosphate, lithium ion or nickel metal-hydride chemistry.

5. The bicycle of claim 1, wherein said electric DC motor supplies a forward torque to said rear wheel.

6. The bicycle of claim 1, wherein said electric DC motor supplies a backward torque to said rear wheel.

7. The bicycle of claim 1, wherein said rear wheel stand is rotatably connected to or nearof said rear wheel

8. A multi-purpose bicycle, comprising:
a frame;
a front wheel and a rear wheel coupled to said frame;
an electric DC motor operably coupled to one of said wheels;
a multiple mode selection switch; and
a torque selection switch.

9. The multi-purpose bicycle of claim 8, wherein said four mode selection switch controls whether said multi-purpose bicycle is in standard mode, electric mode, stationary gym mode, or mobile gym mode.

10. The multi-purpose bicycle of claim 8, wherein said torque selection switch controls whether said electric DC motor places forward torque or backward torque to said bicycle, as well as how much torque is provided.

11. The multi-purpose bicycle of claim 9, wherein in said standard mode, said electric DC motor is off and said bicycle is pedaled by a user.

12. The multi-purpose bicycle of claim 9, wherein in said electric mode, said electric DC motor is on and said torque selection switch is set to forward, so that said electric DC motor supplies a forward torque to said bicycle, in order to assist a user in pedaling said bicycle.

13. The multi-purpose bicycle of claim 9, wherein in said electric mode, said electric DC motor is on and said torque selection switch is set to backward, so that said electric DC motor supplies a backward torque to said rear wheel of said bicycle, in order to provide resistance to pedaling said bicycle.

14. The multi-purpose bicycle of claim 9, wherein in said stationary gym mode, said electric DC motor is off, and a rear wheel stand lifts said rear wheel off of a surface, so that said rear wheel of said bicycle can spin without moving said bicycle, transforming said bicycle into a standalone exercise bicycle.

15. The multi-purpose bicycle of claim 9, wherein in said stationary gym mode, pedaling of said bicycle recharges said electric DC motor's battery.

16. The multi-purpose bicycle of claim 9, wherein in said mobile gym mode, said electric DC motor is on, and said rear wheel stand lifts said rear wheel off of a surface, and said torque selection switch is set to forward, so that said bicycle can be used as a standalone exercise bicycle, in which said electric DC motor supplies a forward torque to said bicycle in order to assist a user in pedaling said bicycle.

17. The multi-purpose bicycle of claim 9, wherein in said mobile gym mode, said electric DC motor is on, and said back wheel stand lifts said rear wheel off of a surface, and said torque selection switch is set to backward, so that said bicycle can be used as a standalone exercise bicycle, in which said electric DC motor supplies a backward torque to said rear wheel in order to provide resistance to pedaling said bicycle.

18. The multi-purpose bicycle of claim 9, wherein in said mobile gym mode, pedaling of said bicycle recharges said electric DC motor's battery.

19. A method of using a multi-purpose bicycle, comprising:
providing a multi-purpose bicycle, comprising:
a frame;
a front wheel and a rear wheel coupled to said frame;
an electric DC motor operably coupled to one of said wheels;
a multiple mode selection switch; and
a torque selection switch; and
using said multi-purpose bicycle in standard mode, or
using said multi-purpose bicycle in electric mode, or
using said multi-purpose bicycle in stationary gym mode, or
using said multi-purpose bicycle in mobile gym mode.

20. The method of claim 19, wherein in said electric mode, said electric DC motor provides forward or backward torque to said bicycle.

21. The method of claim 19, wherein in said stationary gym mode, a rear wheel stand is
rotated downward to raise said rear wheel from a surface.

22. The method of claim 19, wherein in said mobile gym mode, a rear wheel stand is
rotated downward to raise said rear wheel from a surface, and said electric DC motor provides a forward of backward torque to said rear wheel.
